(19) United States
(12) Patent Application Publication
(10) Pub. No.: US 2025/0208806 A1
(43) Pub. Date: Jun. 26, 2025

(54) NON-TRANSITORY COMPUTER-READABLE STORAGE MEDIUM STORING SET OF INSTRUCTIONS OF LABEL EDITING PROGRAM FOR EDITING LABEL DATA

(71) Applicant: BROTHER KOGYO KABUSHIKI KAISHA, Nagoya (JP)

(72) Inventor: Ryo KOYASHIKI, Nagoya (JP)

(21) Appl. No.: 18/983,318

(22) Filed: Dec. 16, 2024

(30) Foreign Application Priority Data
Dec. 26, 2023 (JP) 2023-219640

(51) Int. Cl. G06F 3/12

(52) U.S. Cl. CPC G06F 3/1258; G06F 3/1205; G06F 3/1225; G06F 3/126

(57) ABSTRACT

A non-transitory computer-readable storage medium stores a set of instructions of a label editing program for editing label data to be printed. The set of instructions, when executed by a computer of an information processing apparatus, causes the computer to perform an acquisition process, a first determination process, a first setting process, and a first display process. The acquisition process includes acquiring a specific piece of printer information including attribute information. The first determination process includes determining, as an operational display mode, a display mode from among a plurality of display modes. The first setting process includes setting the operational display mode based on the display mode determined as the operational display mode in the first determination process. The first display process includes displaying, on a user interface of the information processing apparatus, a screen corresponding to the operational display mode set in the first setting process.

### REFERENCE TO RELATED APPLICATIONS

This application claims priority from Japanese Patent Application No. 2023-219640 filed on Dec. 26, 2023. The entire content of the priority application is incorporated herein by reference.

### BACKGROUND ART

Conventionally, some programs have been configured to offer multiple display modes with different display formats and to set one of the display modes as the operational display mode during installation or initial startup of the program. For example, conventional printer driver software, when being installed on an information processing apparatus, examines the types of programs already installed on the apparatus. If there are many types of programs installed, the software displays a screen for configuring complex print settings. If there are not many types of programs, the software queries the user about the user's intended use and displays a screen with print settings appropriate for that use.

### SUMMARY

In a label editing program with which users can edit data to be printed on label printers, templates that can facilitate the user in editing differ according to the application of the label printer. For this reason, the label editing program is preferably provided with multiple display modes having different display formats and can be operated in a display mode suited to the label printer being used by the user. In this case, an operational display mode must be set, but the user may be confused about which display mode to select. Automatically setting a display mode according to the number of types of programs, as in the conventional technology described above, may not necessarily set the display mode most suitable for the label printer being used by the user.

In view of the foregoing, it is an object of the present disclosure to provide a technology that can increase the likelihood that a display mode suitable for a label printer used by a user is selected.

In order to attain the above and other objects, according to one aspect, the present disclosure provides a non-transitory computer-readable storage medium storing a set of instructions of a label editing program for editing label data to be printed. The set of instructions of the label editing program, when executed by a computer of an information processing apparatus, causes the computer to perform an acquisition process at an initial startup of the label editing program, a first determination process in response to performing the acquisition process, a first setting process, and a first display process. The acquisition process includes acquiring a specific piece of printer information from among one or more pieces of printer information stored in the information processing apparatus. Each of the one or more pieces of printer information corresponding to a respective one of one or more label printers. Each of the one or more label printers has a function to print the label data. Each of the one or more pieces of printer information includes attribute information for identifying whether an application attribute of the corresponding label printer is either a first attribute or a second attribute. The application attribute is an attribute based on an application of the corresponding label printer. The first determination process includes determining, as an operational display mode, a display mode from among a plurality of display modes. The plurality of display modes includes a first display mode and a second display mode having a different display format from the first display mode. The determining includes: determining the first display mode as the operational display mode when the application attribute identified by the attribute information included in the specific piece of printer information acquired in the acquisition process is the first attribute; and determining the second display mode as the operational display mode when the application attribute identified by the attribute information included in the specific piece of printer information acquired in the acquisition process is the second attribute. The first setting process includes setting the operational display mode based on the display mode determined as the operational display mode in the first determination process. The first display process includes displaying, on a user interface of the information processing apparatus, a screen corresponding to the operational display mode set in the first setting process.

In the above configuration, printer information possessed by the information processing apparatus is acquired during the initial startup of the label editing program. A display mode is determined as the operational display mode according to the application attribute identified by the acquired printer information. The operational display mode is set based on the display mode determined as the operational display mode. This configuration increases the likelihood that a suitable display mode for the label printer used by the user is set.

According to another aspect, the present disclosure provides an installation method of installing a label editing program for editing label data to be printed. The installation method comprises installing the label editing program on an information processing apparatus. The installing includes an acquisition process, a first determination process in response to performing the acquisition process, and a first setting process. The acquisition process includes acquiring printer information stored in the information processing apparatus. The printer information corresponds to a label printer having a function to print the label data. The printer information includes attribute information for identifying whether an application attribute of the corresponding label printer is either a first attribute or a second attribute. The application attribute is an attribute based on an application of the corresponding label printer. The first determination process includes determining, as an operational display mode, a display mode from among a plurality of display modes. The plurality of display modes includes a first display mode and a second display mode having a different display format from the first display mode. The determining includes: determining the first display mode as the operational display mode when the application attribute identified by the attribute information included in the printer information acquired in the acquisition process is the first attribute; and determining the second display mode as the operational display mode when the application attribute identified by the attribute information included in the printer information acquired in the acquisition process is the second attribute. The first setting process includes setting the operational display mode based on the display mode determined as the operational display mode in the first determination process. A set of instructions of the label editing program, when executed by a computer of the information processing apparatus, causes the computer to perform operations for editing label data. The operations include displaying, on a user interface of the information processing apparatus, a screen corresponding to the operational display mode set in the first setting process.

According to still another aspect, the present disclosure provides a control method for an information processing apparatus on which a label editing program for editing label data to be printed is installable. The control method comprises an acquisition process, a first determination process, and a first setting process. The acquisition process includes acquiring printer information stored in the information processing apparatus. The printer information corresponds to a label printer having a function to print the label data. The printer information includes attribute information for identifying whether an application attribute of the corresponding label printer is either a first attribute or a second attribute. The application attribute is an attribute based on an application of the corresponding label printer. The first determination process includes determining, as an operational display mode, a display mode from among a plurality of display modes. The plurality of display modes includes a first display mode and a second display mode having a different display format from the first display mode. The determining includes: determining the first display mode as the operational display mode when the application attribute identified by the attribute information included in the printer information acquired in the acquisition process is the first attribute; and determining the second display mode as the operational display mode when the application attribute identified by the attribute information included in the printer information acquired in the acquisition process is the second attribute. The first setting process includes setting the operational display mode based on the display mode determined as the operational display mode in the first determination process. A set of instructions of the label editing program, when executed by a computer of the information processing apparatus, causes the computer to perform operations for editing label data. The operations include displaying, on a user interface of the information processing apparatus, a screen corresponding to the operational display mode set in the first setting process.

An installer and information processing apparatus are also novel and useful for realizing the functions of the label editing program.

The above configurations can facilitate the selection of a display mode suitable for the label printer used by the user.

### BRIEF DESCRIPTION OF DRAWINGS

FIG. 1 is an explanatory diagram schematically illustrating an information processing apparatus.

FIGS. 2A and 2B are diagrams explaining example data structures.

FIG. 3 is a flowchart explaining example steps for a startup process.

FIG. 4 is a flowchart explaining example steps for an acquisition process.

FIG. 5 is a flowchart explaining example steps for a mode determination process.

FIG. 6 is a diagram explaining an example mode selection screen.

FIGS. 7A and 7B are diagrams explaining example initial screens.

FIG. 8 is a flowchart explaining example steps for an install process executed by an information processing apparatus.

FIG. 9 is a flowchart explaining example steps for another acquisition process.

FIG. 10A is a flowchart explaining example steps for another acquisition process.

FIG. 10B is a flowchart explaining example steps for another mode determination process.

### DESCRIPTION

Below, an information processing apparatus according to the present embodiment will be described while referring to the accompanying drawings. Specifically, a personal computer 1 on which a label editing program for editing label data has been installed will be described as an example of the information processing apparatus. Hereinafter, the personal computer 1 will be referred to as “PC 1”.

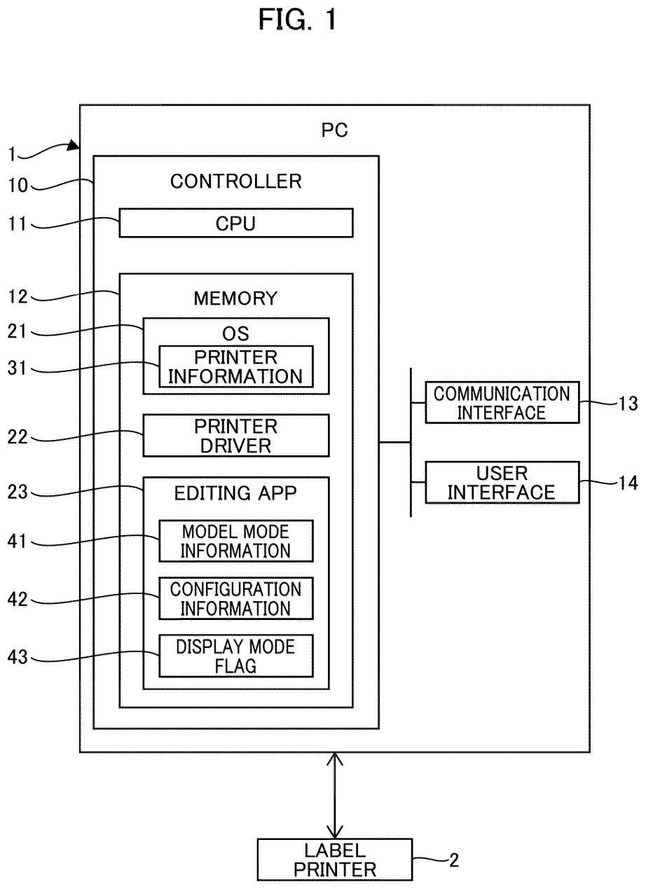

As shown in FIG. 1, the PC 1 in this embodiment is an apparatus provided with a communication function, a display function, and an operation function. The PC 1 may also be a portable terminal such as a smartphone or a tablet terminal. The PC 1 is an example of the information processing apparatus.

The PC 1 is communicatively connectable to label printers 2. Each of the label printers 2 is configured to create labels. More specifically, each of the label printers 2 has a function to print label data to create labels. The label printer 2 has a function to form images on print media such as tape based on instructions from the PC 1 or the like. The label printer 2 includes a thermal transfer type print head, for example, and performs printing while paying out tape wound in a roll. The label printer 2 conveys the tape accommodated therein while printing images on the tape based on a print job received from the PC 1, for example. Subsequently, the label printer 2 protrudes the printed portion of the tape outward from the label printer 2, thereby creating a label having a prescribed length and width. The print media may be sheets of paper, seals affixed to a release paper, and the like. The seals are cut to predetermined shapes, such as rectangular or flag shapes. In addition, the print media may be laminated or otherwise specially processed. The label printer 2 may be an apparatus configured to print in monochrome or color.

The label printers 2 have different models. The applications of the label printers 2 differ based on the respective models. For example, the applications include general applications for the home and office, and specialized applications for electrical work, information communications, and the like. Specifically, the label printers 2 differ in printing methods, compatible tapes, and available options based on the respective models. Each of the models of the label printers 2 also has a different mode of use such as stationary or portable types.

Each label printer 2 is configured to be connected to the PC 1 through a wireless LAN communication technology such as Wi-Fi (“Wi-Fi” is a registered trademark of Wi-Fi Alliance) or a short-range wireless technology such as Bluetooth (“Bluetooth” is a registered trademark of Bluetooth SIG, Inc.). Communication between the label printer 2 and the PC 1 may also be configured through a wired connection according to the USB communication standard.

The number of the label printers 2 that are connected to the PC 1 is not limited to one (1) and may be two (2) or more. When the number of the label printers 2 that are connected to the PC 1 is two or more (i.e., when a plurality of label printers 2 is connected to the PC 1), the applications or models of the label printers 2 may be the same or different. The PC 1 may also be connected to printers of types other than label printers 2.

The PC 1 in this embodiment includes a controller 10. The controller 10 includes a CPU 11 and a memory 12. The CPU 11 is an example of the computer. The PC 1 further includes a communication interface 13, and a user interface 14, both of which are electrically connected to the controller 10. Note that the controller 10 in FIG. 1 is a general concept that covers all hardware and software used for controlling the PC 1 and does not necessarily represent a single piece of hardware actually present in the PC 1.

The CPU 11 executes various processes according to programs read from the memory 12 or based on user operations. The memory 12 stores therein various programs and various data. The memory 12 is also used as a work area for executing various processes. The memory 12 is a non-transitory computer-readable storage medium. A buffer provided in the CPU 11 is also one example of memory. Examples of the memory 12 may be ROM, RAM, a hard disk drive, or the like built into the PC 1 or may be any storage medium that is readable and writable by the CPU 11, such as CD-ROM or DVD-ROM. In the following description, the CPU 11 executing a program will also be simply referred to by the program name. For example, “the editing app 23” may also be used to signify “the CPU 11 executing the editing app 23.”

The communication interface 13 includes hardware for communicating with external apparatuses. The communication standard employed by the communication interface 13 may be Ethernet (“Ethernet” is a registered trademark of FUJIFILM Business Innovation Corp. in Japan), Wi-Fi, Universal Serial Bus (USB), or the like. Alternatively, the PC 1 may be provided with a plurality of communication interfaces 13 supporting a plurality of communication standards. The PC 1 can connect to the label printers 2, for example, via the communication interface 13.

The user interface 14 includes hardware that displays screens for reporting information to the user, and hardware that receives user operations. The user interface 14 may be a combination of devices including a display configured to display information, and a mouse, keyboard, and the like with input-receiving functions. Alternatively, the user interface 14 may be a touchscreen equipped with both a display function and an input-receiving function.

The memory 12 of the PC 1 stores therein an operating system 21, a printer driver 22, and an editing application program 23. That is, the memory 12 stores therein a set of instructions of the editing application program 23. Hereinafter, the operating system 21 will be called an “OS 21”, and the editing application program will be called an “editing app 23”. The editing app 23 is an example of the label editing program. The OS 21 may be one of Windows (“Windows” is a registered trademark of Microsoft Corporation), macOS (“macOS” is a registered trademark of Apple Inc.), Linux (“Linux” is a registered trademark of Linus Torvalds), iOS (“iOS” is a registered trademark of Cisco Systems, Inc.), and Android (“Android” is a registered trademark of Google Inc.), for example.

The OS 21 has a function for creating a printer queues for each printer connected to the PC 1. The OS 21 has a function for managing a piece of printer information associated with each printer queue. The OS 21 can acquire a piece of printer information from a printer connected to the PC 1 or a printer driver supporting that printer and store, in the PC 1 (and more specifically in a storage area provided for the OS 21 in the memory 12), this piece of printer information in association with the corresponding printer queue (i.e., the printer queue for that printer). Pieces of printer information stored in the PC 1 in associated with the printer queues for the label printers 2 will be called the “pieces of printer information 31” or “printer information 31”. Each of the pieces of printer information 31 includes information on the corresponding label printer 2. In other words, each of the pieces of printer information 31 includes information on the label printer 2 for which the printer queue associated with the piece of printer information 31 is created.

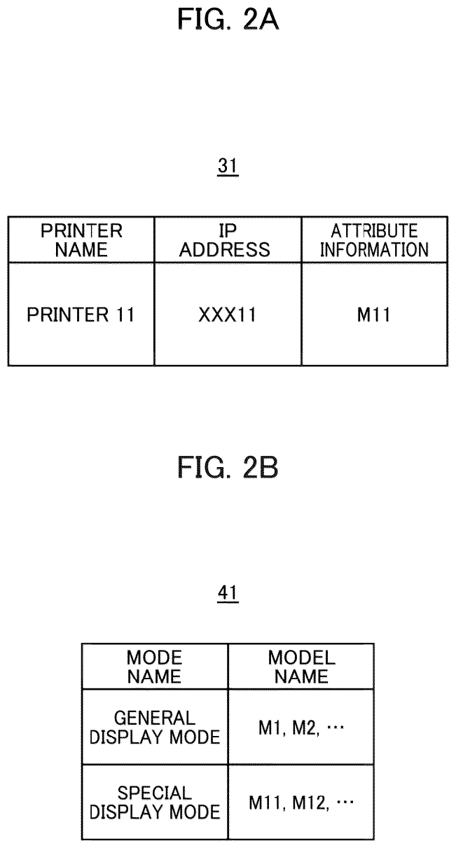

As shown in the example of FIG. 2A, each piece of printer information 31 includes attribute information on the corresponding label printer 2. The attribute information is information for identifying an application attribute of the corresponding label printer 2. The application attribute is an attribute (or a characteristic) of the label printer 2 that is based on the applications of the label printer 2, i.e., an attribute of the label printer 2 that pertains to the applications of the label printer 2. For example, the attribute information may be the model name of the label printer 2 (i.e., the model of the label printer 2). In addition to the attribute information, the piece of printer information 31 may include the printer name and IP address of the label printer 2, for example. The piece of printer information 31 may further include information on the port to print, initial values for print settings, and the like.

Returning to FIG. 1, the printer driver 22 and editing app 23 are programs supplied by the vendor of the label printers 2. The editing app 23 can support a plurality of models of the label printers 2. The editing app 23 may be installed on the PC 1 in combination with the printer driver 22 or may be installed on the PC 1 separately from the printer driver 22.

The printer driver 22 has functions for communicating with the label printer 2 to control operations of the same. The printer driver 22 has a function for accepting print settings and image data, a function for generating print data based on the image data, and a function for outputting the print data to the label printer 2. The printer driver 22 is started up in response to receiving a print instruction or an instruction to display a screen for configuring print settings from the editing app 23 described below, for example.

The editing app 23 is a program that accepts at least instructions for creating and editing images to be printed on labels, and instructions to print those images. Additionally, the editing app 23 may accept instructions to save images, for example. The editing app 23 has various prepared screens, including an initial screen and an editing screen. The editing app 23 has a plurality of display modes with different display formats.

The label printer 2 in the present embodiment can be identified by its model as either a label printer for general use (a general-purpose label printer) or a label printer for specialized use (a specialized label printer). That is, the application attribute of the label printer 2 can be identified by the attribute information as either a general-purpose use or a specialized use. The general use is an example of the “first attribute,” while the specialized use is an example of the “second attribute.” The editing app 23 of this embodiment can support both label printers for general use and label printers for specialized use. The editing app 23 has a general display mode with a display format suitable for general-purpose label printers, and a special display mode with a display format suitable for specialized label printers. The general display mode is an example of the “first display mode.” The special display mode is an example of the “second display mode.”

The editing app 23 has a function for setting the display mode. Once the display mode has been set, the editing app 23 displays a screen corresponding to that display mode. The display mode setting function will be described later.

The editing app 23 is provided with model mode information 41, configuration information 42, and a display mode flag 43. The model mode information 41, configuration information 42, and display mode flag 43 are stored in a storage area provided for the editing app 23 in the memory 12, such as the registry when the OS 21 is Windows.

The model mode information 41 is information associating mode names with model names, as illustrated in the example of FIG. 2B. The mode name is the name of the display mode. The model name is the name of the model of the label printer 2. One or a plurality of model names may be associated with a mode name.

The configuration information 42 includes information set for the editing app 23. Specifically, the configuration information 42 includes mode information indicating the display mode set in the editing app 23. Content of the mode information can be changed through user operations. In addition to the mode information, the configuration information 42 may include printer information on the printer selected through the editing app 23 and print settings for that printer.

When updated, the editing app 23 can store the configuration information that was set in the version prior to the update (hereinafter called the “old version”) in the storage area for the editing app 23 separately from the configuration information 42 of the new version. In this case, the editing app 23 can pass on the configuration information of the old version and store this configuration information as the configuration information 42 of the new version at the time of the update. The old version of the editing app 23 is an example of the pre-update version of the label editing program.

The display mode flag 43 is information indicating whether the display mode has been set for the editing app 23. The display mode flag 43 is set to OFF when the editing app 23 is installed. The display mode flag 43 is switched from OFF to ON when the display mode is set. When updated, the editing app 23 does not pass on the display mode flag set in the old version (i.e., the display mode flag 43 is set to OFF). Hence, the display mode flag 43 of the new version has already been set to OFF when the editing app 23 is first started up after being updated.

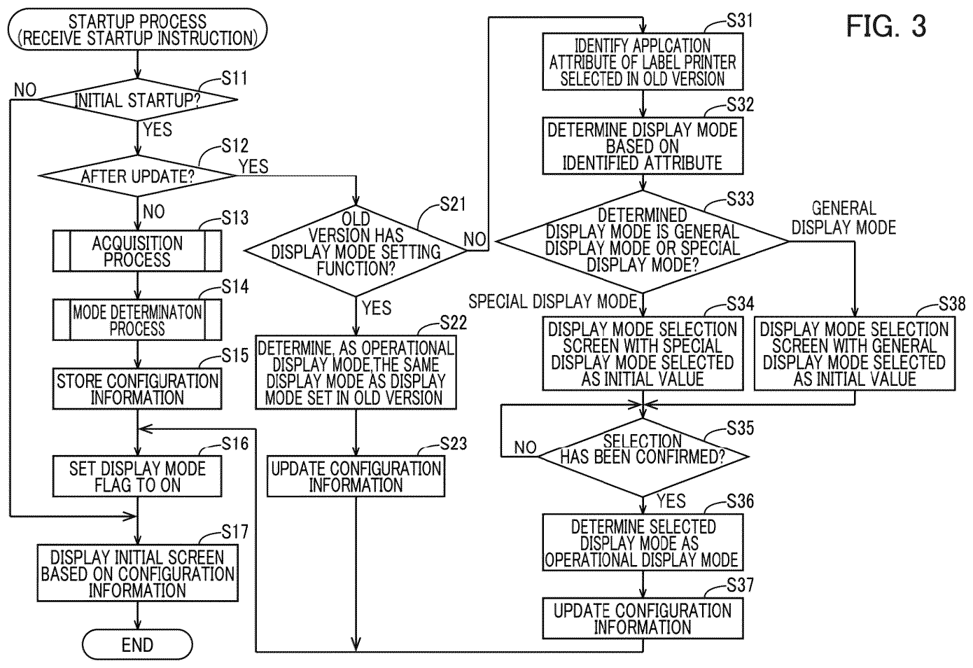

Next, the display mode setting function of the editing app 23 will be described with reference to the flowchart shown in FIG. 3. When the editing app 23 is installed on the PC 1, the PC 1 generates a startup icon for starting the editing app 23. When an operation on the startup icon is received, the PC 1 starts up the editing app 23 and begins the startup process shown in FIG. 3. Processes in the following description and each process step in the flowcharts essentially indicates a process performed by the CPU 11 according to instructions written in the editing app 23 and other programs.

After the PC 1 starts up the editing app 23 and begins the startup process, in S11 the CPU 11 first determines whether this startup (the current startup) of the editing app 23 is an initial startup. When the display mode flag 43 has been set to OFF, the CPU 11 determines that this startup is an initial startup (S11: YES). Here, the “initial startup” refers not only to the first time the editing app 23 is started after the editing app 23 is installed on the PC 1 (the initial startup after the installation of the editing app 23 on the PC 1) but also to the first time the editing app 23 is started after the editing app 23 is updated (the initial startup after an update of the editing app 23). In S12 the CPU 11 determines whether this startup is after the editing app 23 is updated.

When no configuration information is stored in the memory 12 for an old version, the CPU 11 determines that the editing app 23 has been installed on the PC 1 for the first time and that this startup is not following an update (S12: NO). In S13 the CPU 11 executes an acquisition process to acquire printer information 31 stored on the PC 1.

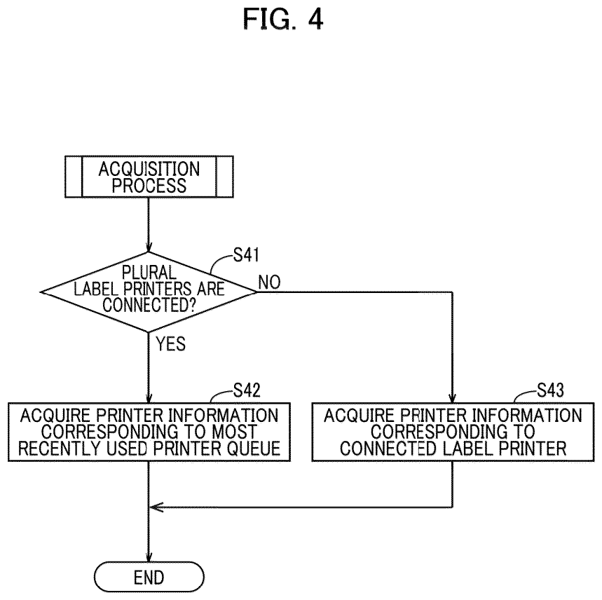

The acquisition process will be described next with reference to FIG. 4. In S41 of FIG. 4, the CPU 11 accesses the OS 21 and determines whether a plurality of label printers 2 are connected to the PC 1 (i.e., whether the number of label printers 2 connected to the PC 1 is greater than one (1)). When confirming with the OS 21 that there is only one printer queue associated with a label printer 2 (i.e., that the number of pieces of printer information 31 stored in the PC 1 is one (1)), the CPU 11 determines that a plurality of label printers 2 is not connected to the PC 1 (S41: NO). In S43 the CPU 11 acquires a piece of printer information 31 stored in association with this printer queue from the OS 21 and subsequently ends the acquisition process. The piece of printer information 31 acquired in S43 is an example of the specific piece of printer information.

When there are multiple printer queues associated with label printers 2 (i.e., when the number of pieces of printer information 31 stored in the PC 1 is greater than one (1)), the CPU 11 determines that a plurality of label printers 2 are connected to the PC 1 (S41: YES). In this case, in S42 the CPU 11 identifies the most recently used printer queue and acquires a piece of printer information 31 associated with the identified printer queue from the OS 21. Subsequently, the CPU 11 ends the acquisition process. The piece of printer information 31 acquired in S42 is also an example of the specific piece of printer information.

Returning to FIG. 3, after completing the acquisition process, in S14 the CPU 11 executes a mode determination process for determining an operational display mode (the display mode for operation).

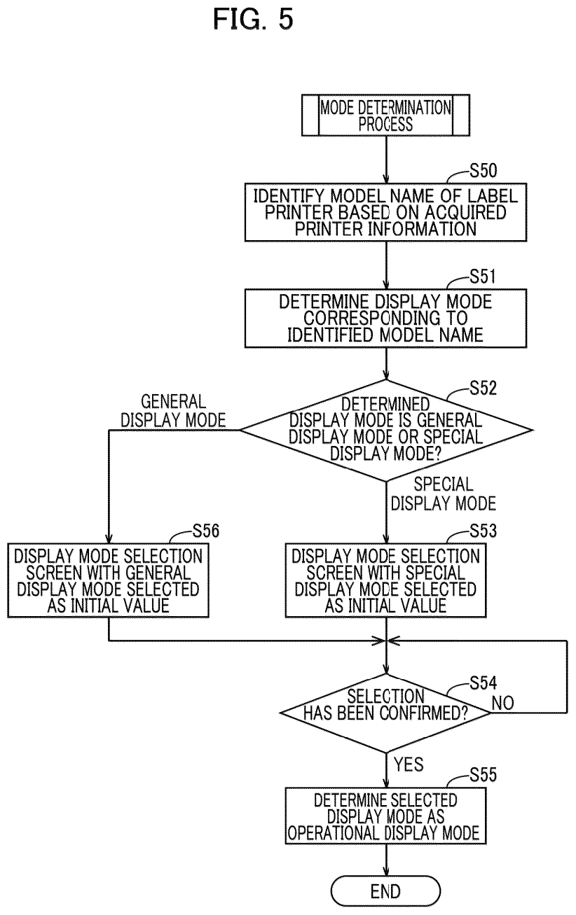

The mode determination process will be described next with reference to FIG. 5. In S50 of FIG. 5, the CPU 11 identifies the model name of the label printer 2 based on the piece of printer information 31 acquired in the acquisition process. In S51 the CPU 11 looks up the model name identified in S50 in the model mode information 41 and determines the display mode associated with the identified model name as the operational display mode. The process from S50 to S51 is an example of the first determination process. In S52 the CPU 11 determines whether the display mode determined as the operational display mode in S51 is the general display mode or the special display mode.

The CPU 11 sets the initial values (the default values) of display mode options (control elements) based on the display mode determined in S51 and displays a mode selection screen.

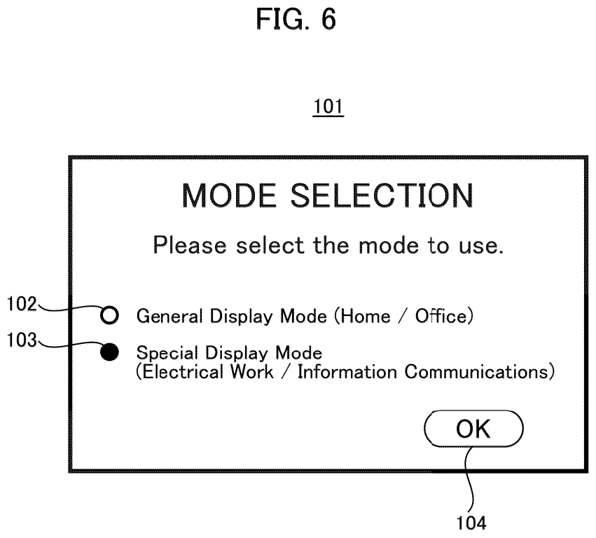

As shown in the example of FIG. 6, the editing app 23 displays a mode selection screen 101 on the user interface 14 for receiving a selection of a display mode from the plurality of display modes. The selection screen 101 is an example of the selection screen. The mode selection screen 101 includes a first selection button 102, a second selection button 103, and an OK button 104. The first selection button 102 is a control element (an interactive control) for selecting the general display mode. The second selection button 103 is a control element (an interactive control) for selecting the special display mode. The OK button 104 is a control element (an interactive control) for receiving an instruction to confirm (finalize) the selection for the display mode. The first selection button 102 is an example of the option. The second selection button 103 is also an example of the option.

When the display mode determined as the operational display mode in S51 is the special display mode (S52: special display mode), in S53 the CPU 11 displays the mode selection screen 101 with the second selection button 103 selected. That is, in the mode selection screen 101 displayed in S53, the special display mode is pre-set as a default choice (the initial value) among display mode options (among the plurality of display modes). On the other hand, when the display mode determined as the operational display mode in S51 is the general display mode (S52: general display mode), in S56 the CPU 11 displays the mode selection screen 101 with the first selection button 102 selected. That is, in the mode selection screen 101 displayed in S56, the general display mode is pre-set as a default choice (the initial value) among the display mode options (among the plurality of display modes). By operating the first selection button 102 and second selection button 103, the user can change the display mode from the default choice (its initial value). The mode selection screen 101 displayed in S53 and S56 is an example of the first selection screen.

After completing S53 or S56, in S54 the CPU 11 determines whether the selection for the display mode has been confirmed (finalized). When the CPU 11 has not received an operation on the OK button 104, the CPU 11 determines that the selection for the display mode has not been confirmed (S54: NO) and continues to wait.

However, when an operation on the OK button 104 has been received, the CPU 11 determines that the selection for the display mode has been confirmed (S54: YES). In S55 the CPU 11 determines the display mode selected in the mode selection screen 101 as the operational display mode. In other words, when the display mode has not been modified from the initial value, the editing app 23 determines the display mode determined in S51 as the operational display mode. When the display mode has been changed in the mode selection screen 101 from the initial value, the editing app 23 determines the modified display mode as the operational display mode. Subsequently, the CPU 11 ends the mode setting process. The process from S52 to S56 is an example of the first selection process.

Returning to FIG. 3, in S15 the CPU 11 stores in the configuration information 42 the display mode determined as the operational display mode in the mode determination process. In other words, the editing app 23 sets the operational display mode to the display mode determined in S55 of the mode determination process. Through this process, the editing app 23 sets a display mode in the configuration information 42 for the first time. In other words, the editing app 23 sets the operational display mode for the first time. The process of S15 is an example of the first setting process. In S16 the CPU 11 switches the display mode flag 43 from OFF to ON, enabling the CPU 11 to determine that a display mode has been set for the editing app 23.

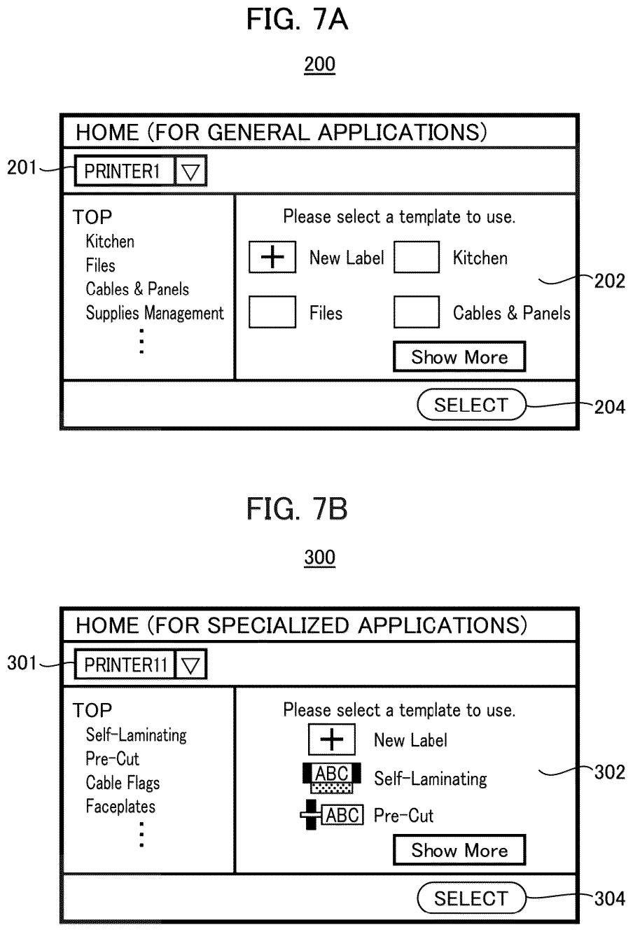

In S17 the CPU 11 displays on the user interface 14 an initial screen based on the configuration information 42 and subsequently ends the startup process. For example, when the display mode set in the configuration information 42 is the general display mode (i.e., when the operational display mode set in S15 is the general display mode), the CPU 11 displays a first initial screen 200 for general applications on the user interface 14, as shown in FIG. 7A. When the display mode set in the configuration information 42 is the special display mode (i.e., when the operational display mode set in S15 is the special display mode), the CPU 11 displays a second initial screen 300 for specialized applications on the user interface 14, as shown in FIG. 7B. That is, in S17 the CPU 11 displays, on the user interface 14, a screen corresponding to the operational display mode set in S15. The process of S17 is an example of the first display process. The first initial screen 200 and the second initial screen 300 are each an example of the screen corresponding to the operational display mode set in the first setting process.

The first initial screen 200 shown in FIG. 7A and the second initial screen 300 shown in FIG. 7B include respective printer selection fields 201 and 301, template selection areas 202 and 302, and Select buttons 204 and 304. Each of the printer selection fields 201 and 301 accepts the selection of a label printer for executing a print. Each of the template selection areas 202 and 302 displays selectable label templates. Each of the Select buttons 204 and 304 is a control element that receives an instruction to confirm (finalize) both the selection of a label printer 2 and the selection of a template.

Templates most convenient for the user to use differ according to the applications of the label printer 2. If both templates suitable for general uses and templates suitable for specialized uses were combined in the initial screen, the user might be confused about which template is best suited for the applications of the label printer 2 being used and have difficulty using the templates.

Therefore, when the general display mode has been set based on the model of the label printer 2, the editing app 23 displays on the user interface 14 the first initial screen 200 showing general use templates in the template selection area 202, as shown in FIG. 7A. On the other hand, when the special display mode has been set based on the model of the label printer 2, the editing app 23 displays on the user interface 14 the second initial screen 300 showing specialized use templates in the template selection area 302, as shown in FIG. 7B. The specialized use templates are different in display content from the general use templates. Since the editing app 23 displays templates on the user interface 14 that are suitable for the model of the label printer 2 being used, the user can more easily select a suitable template for the applications of the label printer 2, making the process user-friendly. The general use templates are each an example of the first template. The specialized use templates are each an example of the second template.

The editing app 23 of this embodiment always sets the display mode upon an initial startup. At this time, the CPU 11 sets the display mode flag 43 to ON. Thus, when the editing app 23 is started up after an initial startup, the CPU 11 can determine that the current startup is not an initial start (S11: NO). In this case, in S17 the CPU 11 displays an initial screen based on the display mode stored in the configuration information 42. In other words, the CPU 11 immediately displays the initial screen without accepting any selection for the display mode. Subsequently, the CPU 11 ends the startup process.

Once installed on the PC 1, the editing app 23 can be updated. When the display mode flag 43 is set to OFF and configuration information of the old version is stored in the memory 12, the editing app 23 determines in the startup process that the current startup is an initial startup after an update of the editing app 23 (S11: YES, S12: YES). The initial startup after an update of the editing app 23 is an example of the post-update initial startup.

In this case, in S21 the CPU 11 determines whether the old version of the editing app 23 is provided with a display mode setting function. When the configuration information of the old version includes mode information, for example, the CPU 11 determines that the editing app 23 of the old version has a display mode setting function, i.e., that the editing app 23 of the old version is provided with a plurality of display modes (S21: YES). In this case, in S22 the CPU 11 determines the same display mode set in the old version as the operational display mode. The process of S22 is an example of the second determination process.

In S23 the CPU 11 updates the configuration information 42 using the display mode determined as the operational display mode in S22. In other words, in S23 the CPU 11 sets the operational display mode to the display mode determined in S22. The process of S23 is an example of the second setting process.

When the old version has a display mode setting function, there is a high probability that the user's preferred display mode is set in the old version. In this case, it is likely that the user would prefer to keep the display mode that was set in the old version after updating the editing app 23. Accordingly, by setting the operational display mode based on the display mode set in the old version, the editing app 23 of the present embodiment can automatically set the display mode based on the display mode set in the old version, for example, without displaying the mode selection screen 101 and prompting the user to confirm the display mode setting. This reduces the user's time and effort required to set the display mode.

Subsequently, in S16 the CPU 11 switches the display mode flag 43 from OFF to ON for the updated editing app 23. In S17 the CPU 11 displays the initial screen based on the display mode set in the configuration information 42 updated in S23. In this case, the process of S17 is an example of the second display process, and the initial screen is an example of the screen corresponding to the operational display mode set in the second setting process. Subsequently, the CPU 11 ends the startup process. Since the process in S16 and S17 has been described above, a description of these steps will not be repeated here.

However, when the configuration information of the old version does not contain mode information, the CPU 11 determines that the editing app 23 in the old version does not have a display mode setting function, i.e., that the editing app 23 in the old version is not provided with any display mode (S21: NO). In this case, in S31 the CPU 11 identifies the application attribute of the label printer 2 selected in the old version. For example, the CPU 11 acquires the printer information 31 for the label printer 2 selected in the old version from the configuration information of the old version. The CPU 11 identifies the application attribute of the label printer 2 selected in the old version based on the attribute information contained in the acquired printer information 31.

In S32 the CPU 11 determines the operational display mode based on the identified application attribute. For example, when the configuration information of the old version includes the model name of the label printer 2 selected in the old version, the CPU 11 looks up this model name in the model mode information 41 to determine the operational display mode. The process from S31 to S32 is an example of the second determination process.

In S33 the CPU 11 determines whether the display mode determined as the operational display mode in S32 is the general display mode or the special display mode. When the CPU 11 determines that the display mode determined in S32 is the general display mode (S33: general display mode), in S38 the CPU 11 displays the mode selection screen 101 on the user interface 14 with the general display mode pre-set as the default choice (the initial value) among the display mode options (among the plurality of display modes). However, when the display mode determined in S32 is the special display mode (S33: special display mode), in S34 the CPU 11 displays the mode selection screen 101 on the user interface 14 with the special display mode pre-set as the default choice (the initial value) among the display mode options (among the plurality of display modes). The mode selection screen 101 displayed in S34 and S38 is an example of the second selection screen.

In S35 the CPU 11 determines whether the display mode selection has been confirmed (finalized). The CPU 11 waits while the display mode selection has not been confirmed (S35: NO). Once the display mode selection has been confirmed through an operation on the OK button 104 in the mode selection screen 101 (S35: YES), in S36 the CPU 11 determines the selected display mode as the operational display mode. Since steps S33-S36 and S38 are identical to S52-S56 of FIG. 5, a detailed description of these steps has been omitted. The process of S33 through S36 and S38 is an example of the second selection process.

In S37 the CPU 11 updates the configuration information 42 using the display mode determined in S36. In other words, in S37 the CPU sets the operational display mode to the display mode determined in S36. The process of S37 is an example of the second setting process.

Note that, in a case where the old version does not have a display mode setting function (i.e., the old version is not provided with any display mode), even when a display mode has been set based on the model of the label printer 2 selected in the old version, the user does not necessarily wish to set that display mode as the operational display mode. Therefore, when a display mode has been set based on the application attribute, such as the model, of the label printer 2 selected in the old version, the editing app 23 in the present embodiment displays the mode selection screen 101 and prompts the user to confirm the setting for the display mode. This gives the user more freedom in setting the display mode, improving user-friendliness.

Subsequently, in S16 the CPU 11 switches the display mode flag 43 from OFF to ON for the updated editing app 23. In S17 the CPU 11 also displays an initial screen based on the display mode set in the configuration information 42 updated in S37. In this case, the process of S17 is an example of the second display process, and the initial screen is an example of the screen corresponding to the operational display mode set in the second setting process. Subsequently, the CPU 11 ends the startup process.

As described above in detail, at an initial startup of the editing app 23 (during an initial startup of the editing app 23), the editing app 23 in this embodiment acquires the printer information 31 stored on the PC 1. The editing app 23 determines a display mode according to the application attribute of the label printer 2 identified by the attribute information (the model name in the present embodiment) acquired from this printer information 31. Then, the editing app 23 sets the operational display mode based on the determined display mode. In this way, the editing app 23 increases the chances that a suitable display mode for the label printer 2 being used by the user is set. Therefore, according to the editing app 23 in this embodiment, label data can be edited and a suitable display mode is likely to be selected for the label printer 2 used by the user.

### Second Embodiment

Next, an information processing apparatus according to a second embodiment of the present disclosure will be described while referring to the accompanying drawings. In the second embodiment, an installer for installing the editing app 23 on the PC 1 sets the display mode of the installed editing app 23. The installer is a separate program from the editing app 23. Thus, the second embodiment differs in this point from the first embodiment in which the editing app 23 sets the display mode itself. The following description will focus on the differences from the first embodiment, wherein like parts and process steps to those in the first embodiment are designated with the same reference numerals and step numbers to avoid duplicating description as appropriate.

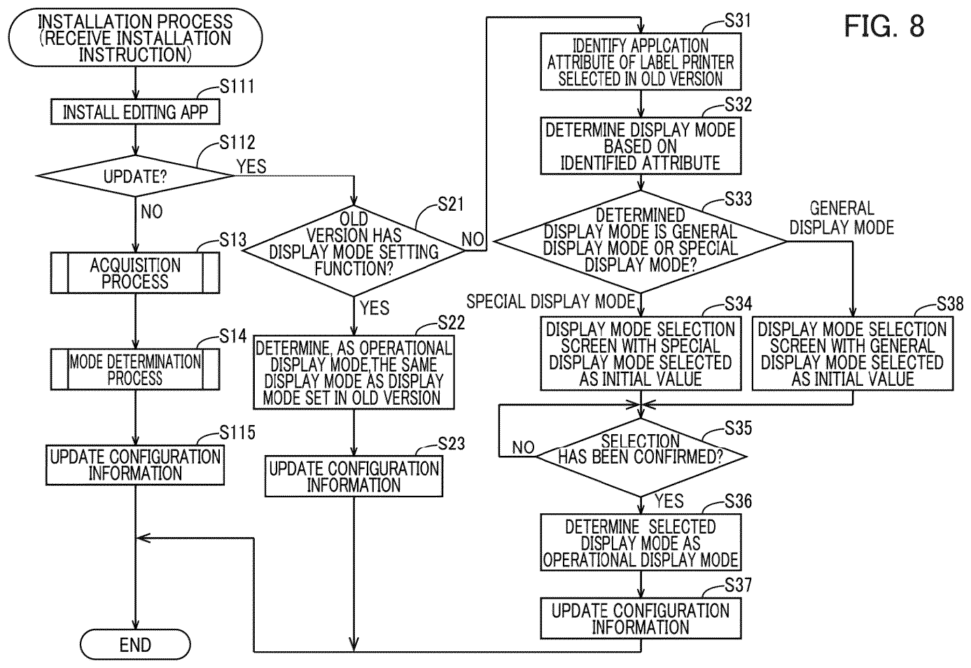

The PC 1 can use an installer that is separate from the editing app 23 to install the editing app 23. Upon receiving an installation instruction to install the editing app 23, the CPU 11 starts the installation process shown in FIG. 8 by executing the installer. Each step in the installation process is performed by the CPU 11 executing the installer. Hereinafter, “the installer” may also be used to signify “the CPU 11 executing the installer.”

In S111 of FIG. 8, the CPU 11 first installs the editing app 23 on the PC 1 using the installer. Here, there are two possible types of installations for the editing app 23: a new installation; and an update installation. A new installation refers to installing the editing app 23 on the PC 1 for the first time. An update installation refers to installing a new version of the editing app 23 on the PC 1 by updating an old version of the editing app 23 already installed on the PC 1 (i.e., by overwriting the old version with the new version). When installing the editing app 23 by updating the old version thereof, the installer stores the configuration information of the old version and the configuration information 42 for the new version in a storage area for the editing app 23 in the memory 12, such as the registry in a case where the OS 21 is Windows. The configuration information 42 of the new version stored at this time is the configuration information passed on from the old version, and the content of settings can be modified through user operations after installation.

In S112 the CPU 11 determines whether the installation of the editing app 23 performed in S111 is an update installation (i.e., whether a new version of the editing app 23 has been installed on the PC 1 by updating the existing old version of the editing app 23). For example, when configuration information of an old version is not stored in the storage area for the editing app 23, the CPU 11 determines that the installation of the editing app 23 performed in S111 is not an update installation and that the editing app 23 is installed for the first time (S112: NO). In this case, the CPU 11 executes the processes in S13 and S14 to determine a display mode as the operational display mode based on the model of the label printer 2 being used. In S115 the PC 1 updates the configuration information 42 using the determined display mode and ends the installation process. That is, in S115 the installer updates the configuration information 42 of the editing app 23 installed in Sill. In other words, in S115 the installer sets the determined display mode as the operational display mode for the editing app 23 installed in Sill. The process of S115 is an example of the first setting process.

However, when configuration information of an old version is stored in the storage area for the editing app 23, the CPU 11 determines that the installation of the editing app 23 performed in S111 is an update installation (S112: YES). In this case, the CPU 11 executes the process in S21-S23 and S31-S38 before ending the installation process. Here, either in S23 or S37 the installer updates the configuration information 42 of the editing app 23 installed in S111.

Hence, the installer of the PC 1 according to the second embodiment sets a display mode for the editing app 23 according to the application attribute of the label printer 2, as in the first embodiment described above. Accordingly, a suitable display mode is likely to be selected for the label printer 2 used by the user.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

For example, the editing app 23 may acquire printer information from the printer driver 22. Further, the display modes are not limited to two types but may be three or more types.

When a configuration is employed in which the printer information 31 can include information indicating the application of the label printer 2, the attribute information may be the application of the label printer 2. In such a case, the editing app 23 may store application mode information associating the display modes and the applications of the label printers 2 and may look up the application contained in the printer information 31 in this application mode information to determine the operational display mode. Further, when the configuration information 42 includes the application of the label printer 2 selected in the old version, for example, in S32 the CPU 11 may look up that application in the application mode information to determine the operational display mode.

Further, steps S53, S54, and S56 of FIG. 5 may be omitted, for example, and in S15 of FIG. 3 the CPU 11 may automatically set the display mode in the configuration information 42 to the display mode determined based on the attribute information contained in the printer information 31. However, after determining a display mode based on attribute information, such as the model name or application, the CPU 11 displays the mode selection screen 101 with the determined display mode pre-set as the default choice (the initial value), as shown in FIG. 5. Hence, by setting the display mode determined above as the initial value among the display mode options in the mode selection screen 101, the CPU 11 facilitates the user in selecting the determined display mode, increasing the chances that this determined display mode (i.e., the display mode suitable for the label printer being used by the user) will be set. Moreover, since the user can select a different display mode from the determined display mode, this method provides a more flexible method of using display modes than when the determined display mode is set automatically.

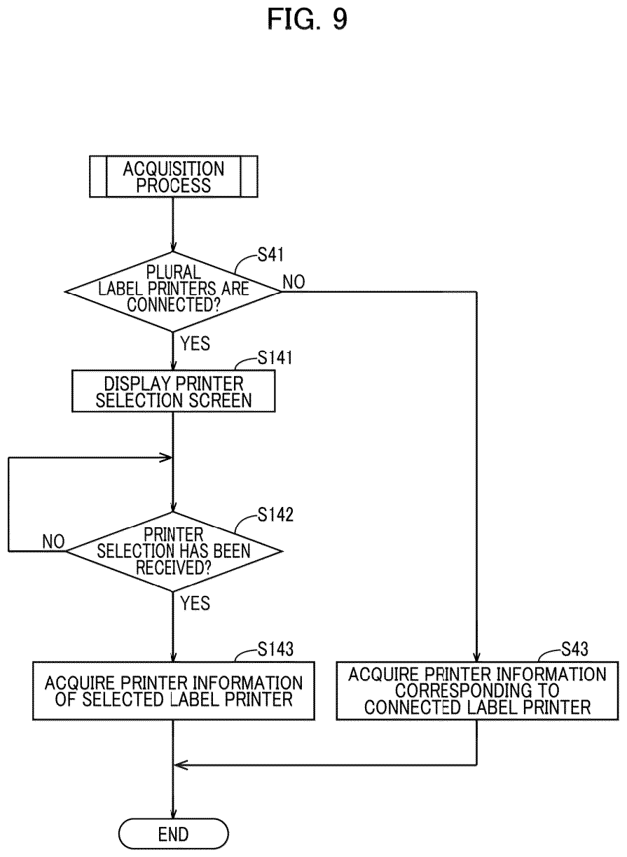

A different method from that shown in FIG. 4 may be used to implement the acquisition process in S13 of FIG. 3. In the acquisition process shown in FIG. 9, for example, when multiple label printers 2 are connected to the PC 1 (S41: YES), in S141 the CPU 11 displays a printer selection screen on the user interface 14 for selecting the printer information 31 of one of the label printers 2 (i.e., for receiving a selection of one piece of printer information from among a plurality of pieces of printer information 31 stored in the PC 1), and in S142 determines whether a label printer 2 has been selected. The CPU 11 continues to wait until a label printer 2 is selected (S142: NO). When the CPU 11 receives a selection for a label printer 2 via the printer selection screen (S142: YES), in S143 the CPU 11 acquires the printer information 31 of the selected label printer 2 from the OS 21. Thus, by prompting the user to select printer information 31 for setting the display mode when a plurality of pieces of printer information 31 is stored in the PC 1, the PC 1 can set a suitable display mode for the label printer 2 that the user is likely to be using. The printer selection screen is an example of the selection screen.

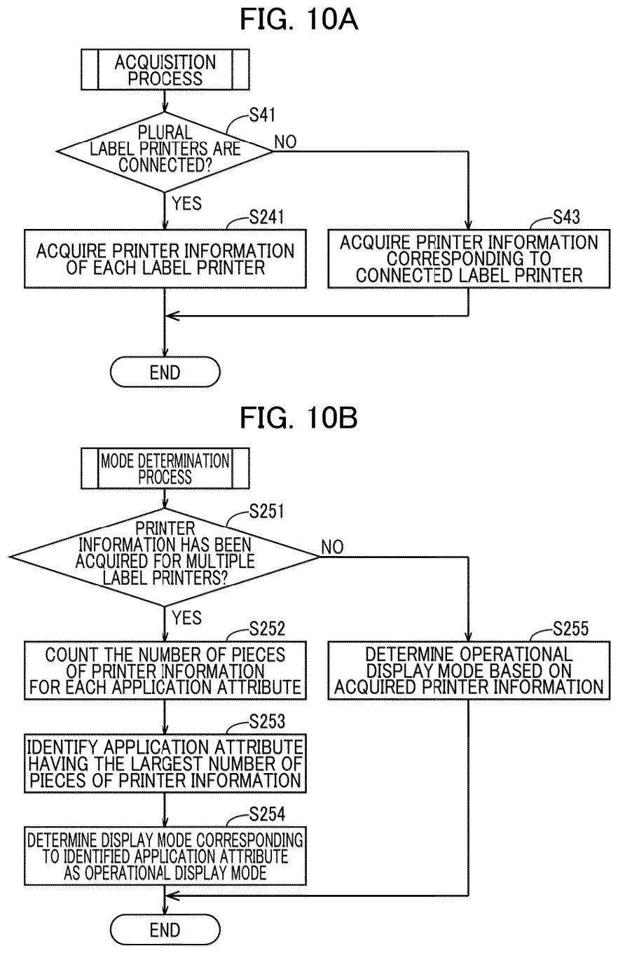

Further, methods different from those shown in FIGS. 4 and 5 may be used to implement the acquisition process of S13 in FIG. 3 and the mode setting process of S14. For example, when multiple label printers 2 are connected to the PC 1 in the acquisition process shown in FIG. 10A (S41: YES), in S241 the CPU 11 acquires the printer information 31 for each label printer 2 from the OS 21, i.e., acquires all pieces of printer information 31 stored in the PC 1. Thus, in the mode setting process shown in FIG. 10B, in S251 the CPU 11 determines whether printer information 31 for multiple label printers 2 has been acquired in S241 (i.e., whether a plurality of pieces of printer information 31 has been acquired in S241). When the CPU 11 determines that printer information 31 for only one label printer 2 has been acquired in S241 (S251: NO), in S255 the CPU 11 determines the operational display mode based on the acquired printer information 31 of that label printer 2.

When the CPU 11 determines that printer information 31 for multiple label printers 2 has been acquired in S241 (S251: YES), in S252 counts the number of pieces of printer information for each of the application attributes (e.g., model names or applications) of the label printers 2. In S253 the CPU 11 identifies the application attribute having the largest number of pieces of printer information 31 and in S254 sets the operational display mode to the display mode corresponding to the identified application attribute. For example, when the number of pieces of printer information 31 containing attribute information indicating the specialized application is greater than the number of pieces of printer information 31 containing attribute information indicating the general application, the CPU 11 sets the operational display mode to the special display mode. The number of pieces of printer information 31 containing attribute information indicating the specialized application is an example of the number of second pieces of printer information. The number of pieces of printer information 31 containing attribute information indicating the general application is an example of the number of first pieces of printer information. The mode setting process shown in FIG. 10B is an example of the first determination process. Thus, when multiple pieces of printer information 31 are stored on the PC 1, there is a greater possibility of setting a suitable display mode for the label printer 2 used by the user by setting the operational display mode to the display mode associated with the most common attribute. In this case as well, the user may be prompted to confirm the choice of display modes through the mode selection screen 101.

However, the label printer 2 linked to printer information 31 associated with the most recently generated printer queue is highly likely to be the most used. Hence, when multiple label printers 2 are connected to the PC 1 (S42), a preferred display mode for the label printer 2 most likely used by the user can be set by acquiring printer information 31 associated with the most recently generated printer queue from the OS 21, as indicated in the acquisition process shown in FIG. 4. When a label printer 2 is set in the OS 21 as the printer normally used (the default printer), for example, the CPU 11 may acquire printer information 31 associated with that label printer 2 in S42 of FIG. 4 instead of the most recent printer information 31. In this case, the editing app 23 can still set a preferred display mode for the label printer 2 that is most likely used by the user.

As another example, steps S21-S23 and S31-S38 in FIG. 3 may be omitted. However, there is a higher probability that a more suitable display mode is set for the label printer 2 used by the user by setting the display mode based on the configuration information 42 set in the old version when the editing app 23 is updated.

Alternatively, only steps S21-S23 of FIG. 3 may be omitted. However, since it is highly likely that the operational display mode has been set when the editing app 23 is updated from an old version having a display mode setting, passing on that setting enables the user to use the same display mode after the update.

Alternatively, only steps S31 and S32 may be omitted from FIG. 3. However, since the previous display mode cannot be passed on to the updated editing app 23 from an old version that does not have a display mode setting function, setting the display mode based on attribute information for the label printer selected in the old version increases the likelihood that a suitable display mode can be set for the updated editing app 23.

Further, steps S33-S36 and S38 may be omitted from FIG. 3. Alternatively, steps S33-S36 and S38 may be performed after S22 to prompt the user to confirm the selection of the display mode. However, when the editing app 23 determines the operational display mode based on the attribute information for the label printer 2 selected in the old version, the editing app 23 can prompt the user to finalize the display mode by displaying the mode selection screen 101, improving the user's freedom in using display modes. On the other hand, when the editing app 23 sets the display mode based on the mode information contained in the configuration information 42 of the old version, the editing app 23 can reduce the user's operational load by eliminating the need for the user to confirm the selection of display modes since it is highly likely that the user would prefer to continue using the same display mode.

The mode selection screen 101 and the first and second initial screens 200 and 300 may have different display formats from those shown in the embodiment. The display formats of screens other than the mode selection screen 101 and the first and second initial screens 200 and 300 may also differ according to the set display mode.

In any of the flowcharts disclosed in the embodiments, the plurality of processes that make up any of the plurality of steps may be executed in parallel, or the order in which the processes are performed may be modified in any way that does not produce any inconsistencies in the processes.

The processes disclosed in the embodiments may be executed by a single CPU, a plurality of CPUs, an ASIC or other hardware, or a combination of these components. Further, the processes disclosed in the embodiments may be achieved through a storage medium that stores the programs used to implement those processes or according to any of various other methods or formats.

What is claimed is:

1. A non-transitory computer-readable storage medium storing a set of instructions of a label editing program for editing label data to be printed, the set of instructions of the label editing program, when executed by a computer of an information processing apparatus, causing the computer to perform:
an acquisition process at an initial startup of the label editing program, the acquisition process including acquiring a specific piece of printer information from among one or more pieces of printer information stored in the information processing apparatus, each of the one or more pieces of printer information corresponding to a respective one of one or more label printers each having a function to print the label data, each of the one or more pieces of printer information including attribute information for identifying whether an application attribute of the corresponding label printer is either a first attribute or a second attribute, the application attribute being an attribute based on an application of the corresponding label printer;
a first determination process in response to performing the acquisition process, the first determination process including determining, as an operational display mode, a display mode from among a plurality of display modes, the plurality of display modes including a first display mode and a second display mode having a different display format from the first display mode, the determining including:
determining, when the application attribute identified by the attribute information included in the specific piece of printer information acquired in the acquisition process is the first attribute, the first display mode as the operational display mode; and
determining, when the application attribute identified by the attribute information included in the specific piece of printer information acquired in the acquisition process is the second attribute, the second display mode as the operational display mode;
a first setting process including setting the operational display mode based on the display mode determined as the operational display mode in the first determination process; and
a first display process including displaying, on a user interface of the information processing apparatus, a screen corresponding to the operational display mode set in the first setting process.

2. The non-transitory computer-readable storage medium according to claim 1,
wherein the attribute information included in each of the one or more pieces of printer information indicates a model of the corresponding label printer,
wherein the label editing program is provided with model mode information associating the model of each of the one or more label printers with one of the plurality of display modes, and
wherein, based on the model mode information, the determining the display mode in the first determination process determines, as the operational display mode, a display mode associated with the model indicated by the attribute information included in the specific piece of printer information acquired in the acquisition process among the plurality of display modes.

3. The non-transitory computer-readable storage medium according to claim 1,
wherein the set of instructions of the label editing program, when executed by the computer, causes the computer to perform:
a first selection process in response to performing the first determination process, the first selection process including:
displaying, on the user interface of the information processing apparatus, a first selection screen for receiving a selection of one display mode from among the plurality of display modes, wherein in the first selection screen the display mode determined as the operational display mode in the first determination process is pre-set as a default choice among the plurality of display modes; and
receiving the selection of one display mode from among the plurality of display modes through the first selection screen, and
wherein the setting in the first setting process sets the operational display mode to the one display mode selected by the selection received through the first selection screen.

4. The non-transitory computer-readable storage medium according to claim 3,
wherein the set of instructions of the label editing program, when executed by the computer, causes the computer to perform, when the initial startup of the label editing program is not a post-update initial startup that is an initial startup after an update of the label editing program:
the acquisition process; the first determination process; the first setting process; and the first display process, and
wherein the set of instructions of the label editing program, when executed by the computer, causes the computer to perform, when the initial startup of the label editing program is the post-update initial startup, in place of the acquisition process, the first determination process, the first setting process, and the first display process:
a second determination process including determining, as the operational display mode, a display mode from among the plurality of display modes based on configuration information set in a pre-update version of the label editing program, the pre-update version of the label editing program being a version of the label editing program before the update;
a second setting process including setting the operational display mode based on the display mode determined as the operational display mode in the second determination process; and
a second display process including displaying, on the user interface of the information processing apparatus, a screen corresponding to the operational display mode set in the second setting process.

5. The non-transitory computer-readable storage medium according to claim 4,
wherein, in a case where the pre-update version of the label editing program is provided with a plurality of display modes, the configuration information includes mode information indicating the operational display mode set in the pre-update version of the label editing program, and
wherein the determining in the second determination process:
determines, when the configuration information includes the mode information indicating the first display mode as the operational display mode set in the pre-update version of the label editing program, the first display mode as the operational display mode; and
determines, when the configuration information includes the mode information indicating the second display mode as the operational display mode set in the pre-update version of the label editing program, the second display mode as the operational display mode.

6. The non-transitory computer-readable storage medium according to claim 5,
wherein the configuration information includes attribute information for identifying whether the application attribute of a label printer selected in the pre-update version of the label editing program is either the first attribute or the second attribute,
wherein, in a case where the pre-update version of the label editing program is not provided with any display mode, the mode information is not included in the configuration information, and
wherein, when the mode information is not included in the configuration information set in the pre-update version of the label editing program, the determining in the second determination process:
determines, when the application attribute identified by the attribute information included in the configuration information is the first attribute, the first display mode as the operational display mode; and
determines, when the application attribute identified by the attribute information included in the configuration information is the second attribute, the second display mode as the operational display mode.

7. The non-transitory computer-readable storage medium according to claim 6,
wherein the set of instructions of the label editing program, when executed by the computer, causes the computer to further perform:
a second selection process in response to performing the second determination process, the second selection process including:
displaying, on the user interface of the information processing apparatus, a second selection screen for receiving a selection of one display mode from among the plurality of display modes, wherein in the second selection screen the display mode determined as the operational display mode in the second determination process is pre-set as a default choice among the plurality of display modes; and
receiving the selection of one display mode from among the plurality of display modes through the second selection screen, and
wherein the setting in the second setting process:
sets, in response to performing the second selection process after the second determination process determines the operational display mode based on the attribute information included in the configuration information, the operational display mode to the one display mode selected in the second selection process; and
sets, in response to the second determination process determining the operational display mode based on the mode information included in the configuration information, the operational display mode to the display mode determined as the operational display mode in the second determination process without displaying the second selection screen.

8. The non-transitory computer-readable storage medium according to claim 1,
wherein, when the number of the one or more pieces of printer information stored in the information processing apparatus is greater than one (1), the acquiring in the acquisition process acquires, as the specific piece of printer information, one piece of printer information corresponding to a specific printer queue from among the one or more pieces of printer information stored in the information processing apparatus, the specific printer queue being a printer queue most recently generated in the information processing apparatus.

9. The non-transitory computer-readable storage medium according to claim 1,
wherein the acquisition process further includes:
displaying, when the number of the one or more pieces of printer information stored in the information processing apparatus is greater than one (1), a selection screen on the user interface of the information processing apparatus, the selection screen being a screen for receiving a selection of one piece of printer information from among the one or more pieces of printer information stored in the information processing apparatus; and
receiving the selection of one piece of printer information from among the one or more pieces of printer information through the selection screen; and
wherein the acquiring in the acquisition process acquires, as the specific piece of printer information, the one piece of printer information selected by the selection received through the selection screen.

10. The non-transitory computer-readable storage medium according to claim 1,
wherein, when the number of the one or more pieces of printer information stored in the information processing apparatus is greater than one (1), the acquiring in the acquisition process acquires all the one or more pieces of printer information, including the specific piece of printer information, and
wherein, without performing the determining the first display mode as the operational display mode or the determining the second display mode as the operational display mode, the determining the display mode in the first determination process:
determines, when the number of first pieces of printer information included in the one or more pieces of printer information is greater than the number of second pieces of printer information included in the one or more pieces of printer information, the first display mode as the operational display mode, the application attribute identified by the attribute information included in each of the first pieces of printer information being the first attribute, the application attribute identified by the attribute information included in each of the second pieces of printer information being the second attribute; and
determines, when the number of the first pieces of printer information is not greater than the number of the second pieces of printer information, the second display mode as the operational display mode.

11. The non-transitory computer-readable storage medium according to claim 1,
wherein the screen displayed on the user interface of the information processing apparatus in the first display process includes:
a first template for the label data when the operational display mode is set to the first display mode in the first setting process; and
a second template for the label data when the operational display mode is set to the second display mode in the first setting process, and
wherein the first template and the second template differ in display content from each other.

12. An installation method of installing a label editing program for editing label data to be printed, the installation method comprising:
installing the label editing program on an information processing apparatus, the installing including:
an acquisition process including acquiring printer information stored in the information processing apparatus, the printer information corresponding to a label printer having a function to print the label data, the printer information including attribute information for identifying whether an application attribute of the corresponding label printer is either a first attribute or a second attribute, the application attribute being an attribute based on an application of the corresponding label printer;
a first determination process in response to performing the acquisition process, the first determination process including determining, as an operational display mode, a display mode from among a plurality of display modes, the plurality of display modes including a first display mode and a second display mode having a different display format from the first display mode, the determining including:
determining, when the application attribute identified by the attribute information included in the printer information acquired in the acquisition process is the first attribute, the first display mode as the operational display mode; and
determining, when the application attribute identified by the attribute information included in the printer information acquired in the acquisition process is the second attribute, the second display mode as the operational display mode; and
a first setting process including setting the operational display mode based on the display mode determined as the operational display mode in the first determination process, wherein a set of instructions of the label editing program, when executed by a computer of the information processing apparatus, causes the computer to perform operations for editing label data, the operations including displaying, on a user interface of the information processing apparatus, a screen corresponding to the operational display mode set in the first setting process.

13. A control method for an information processing apparatus on which a label editing program for editing label data to be printed is installable, the control method comprising:
an acquisition process including acquiring printer information stored in the information processing apparatus, the printer information corresponding to a label printer having a function to print the label data, the printer information including attribute information for identifying whether an application attribute of the corresponding label printer is either a first attribute or a second attribute, the application attribute being an attribute based on an application of the corresponding label printer;
a first determination process in response to performing the acquisition process, the first determination process including determining, as an operational display mode, a display mode from among a plurality of display modes, the plurality of display modes including a first display mode and a second display mode having a different display format from the first display mode, the determining including:
determining, when the application attribute identified by the attribute information included in the printer information acquired in the acquisition process is the first attribute, the first display mode as the operational display mode; and
determining, when the application attribute identified by the attribute information included in the printer information acquired in the acquisition process is the second attribute, the second display mode as the operational display mode; and
a first setting process including setting the operational display mode based on the display mode determined as the operational display mode in the first determination process, wherein a set of instructions of the label editing program, when executed by a computer of the information processing apparatus, causes the computer to perform operations for editing label data, the operations including displaying, on a user interface of the information processing apparatus, a screen corresponding to the operational display mode set in the first setting process.
